(19) United States
(12) Patent Application Publication
(10) Pub. No.: US 2023/0064391 A1
(43) Pub. Date: Mar. 2, 2023

(54) INFORMATION PROCESSING APPARATUS, INFORMATION PROCESSING METHOD, AND INFORMATION PROCESSING PROGRAM

(71) Applicant: FUJIFILM CORPORATION, Tokyo (JP)

(72) Inventors: Yutaka OISHI, Tokyo (JP); Michitaka KONDO, Tokyo (JP); Misaki OTSUKA, Tokyo (JP); Yuko MASUDA, Tokyo (JP)

(21) Appl. No.: 17/815,947

(22) Filed: Jul. 29, 2022

(30) Foreign Application Priority Data
Aug. 26, 2021 (JP) 2021-138395

(51) Int. Cl. G06F 3/06

(52) U.S. Cl. CPC G06F 3/0647; G06F 3/0604; G06F 3/0682

(57) ABSTRACT

An information processing apparatus performs control of recording data in a relatively-new-generation magnetic tape of at least one storage pool among a plurality of storage pools in a case where the same data is recorded in each of the plurality of storage pools each of which includes a plurality of generations of magnetic tapes.

### CROSS-REFERENCE TO RELATED APPLICATIONS

The present application claims priority under 35 U.S.C. § 119 to Japanese Patent Application No. 2021-138395 filed on Aug. 26, 2021. The above application is hereby expressly incorporated by reference, in its entirety, into the present application.

### BACKGROUND

### 1. Technical Field

The present disclosure relates to an information processing apparatus, an information processing method, and an information processing program.

### 2. Description of the Related Art

JP2008-250667A discloses a technique of configuring a storage pool with a plurality of magnetic tapes.

### SUMMARY

It is considered to multiplex and store data by recording the same data in a plurality of storage pools each of which includes a plurality of magnetic tapes. In addition, a plurality of generations of magnetic tapes may coexist in the plurality of magnetic tapes included in the storage pool. Further, in a storage system using magnetic tapes, for the purpose of storing data for a long term, increasing a capacity per magnetic tape, and improving a transmission speed, processing of migrating data recorded in an old-generation magnetic tape to a new-generation magnetic tape (hereinafter, referred to as “inter-generation migration processing) is performed.

In the inter-generation migration processing, since a data-migration-source magnetic tape is an old-generation magnetic tape, there is room for improvement from a viewpoint of shortening a time required for data migration. The technique described in JP2008-250667A does not consider a time required for data migration.

An object of the present disclosure is to provide an information processing apparatus, an information processing method, and an information processing program capable of shortening a time required for data migration.

According to an aspect of the present disclosure, there is provided an information processing apparatus including at least one processor, in which the processor is configured to perform control of recording data in a relatively-new-generation magnetic tape of at least one storage pool among a plurality of storage pools in a case where the same data is recorded in each of the plurality of storage pools each of which includes a plurality of generations of magnetic tapes.

In the information processing apparatus according to the aspect of the present disclosure, a data recordable area may exist only in the relatively-new-generation magnetic tape among the plurality of generations of magnetic tapes in the at least one storage pool.

Further, in the information processing apparatus according to the aspect of the present disclosure, the processor may be configured to perform control of recording data in the one storage pool without designating a magnetic tape as a data recording destination, and perform control of recording data without designating a magnetic tape as a data recording destination in a storage pool other than the one storage pool in a case where the control is performed and data is recorded in the relatively-new-generation magnetic tape of the one storage pool, and perform control of designating a relatively-new-generation magnetic tape as a data recording destination in at least one storage pool other than the one storage pool and recording data in the designated magnetic tape in a case where data is recorded in a relatively-old-generation magnetic tape in the one storage pool.

Further, in the information processing apparatus according to the aspect of the present disclosure, the processor may be configured to perform control of migrating data to be migrated from a relatively-new-generation magnetic tape of a second storage pool to a relatively-new-generation magnetic tape of a first storage pool in a case where the data to be migrated that is recorded in a relatively-old-generation magnetic tape of the first storage pool is migrated to a relatively-new-generation magnetic tape and in a case where the data to be migrated is recorded in the relatively-new-generation magnetic tape of the second storage pool other than the first storage pool.

According to another aspect of the present disclosure, there is provided an information processing method executed by a processor of an information processing apparatus, the method including: performing control of recording data in a relatively-new-generation magnetic tape of at least one storage pool among a plurality of storage pools in a case where the same data is recorded in each of the plurality of storage pools each of which includes a plurality of generations of magnetic tapes.

According to still another aspect of the present disclosure, there is provided an information processing program for causing a processor of an information processing apparatus to execute a process including: performing control of recording data in a relatively-new-generation magnetic tape of at least one storage pool among a plurality of storage pools in a case where the same data is recorded in each of the plurality of storage pools each of which includes a plurality of generations of magnetic tapes.

According to the present disclosure, it is possible to shorten a time required for data migration.

### BRIEF DESCRIPTION OF THE DRAWINGS

FIG. 1 is a block diagram illustrating an example of a configuration of an information processing system.

FIG. 2 is a block diagram illustrating an example of a hardware configuration of an information processing apparatus.

FIG. 3 is a diagram illustrating an example of a tape management table.

FIG. 4 is a diagram for explaining a storage pool.

FIG. 5 is a diagram illustrating an example of a configuration of the storage pool.

FIG. 6 is a block diagram illustrating an example of a functional configuration of the information processing apparatus.

FIG. 7 is a diagram for explaining data migration processing.

FIG. 8 is a flowchart illustrating an example of data recording processing.

FIG. 9 is a flowchart illustrating an example of data migration processing.

FIG. 10 is a diagram illustrating an example of a configuration of a storage pool according to a modification example.

FIG. 11 is a diagram for explaining data recording processing according to a modification example.

FIG. 12 is a diagram for explaining data recording processing according to a modification example.

### DETAILED DESCRIPTION

Hereinafter, an example of an embodiment for performing a technique according to the present disclosure will be described in detail with reference to the drawings.

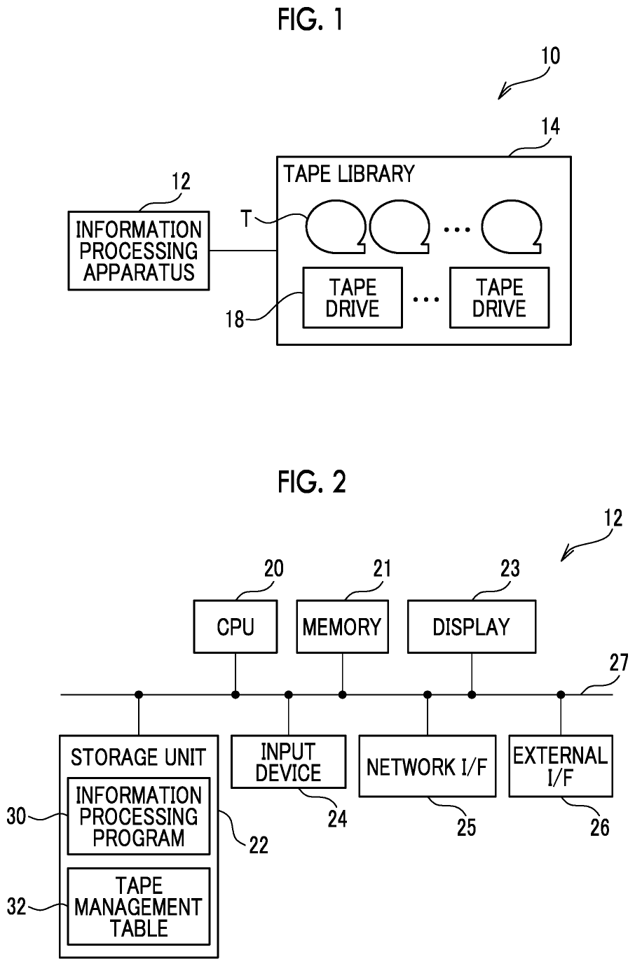

First, a configuration of an information processing system 10 according to the present embodiment will be described with reference to FIG. 1. As illustrated in FIG. 1, the information processing system 10 includes an information processing apparatus 12 and a tape library 14. Examples of the information processing apparatus 12 include a server computer and the like.

The tape library 14 includes a plurality of slots (not illustrated) and a plurality of tape drives 18, and each slot includes a magnetic tape T as an example of a recording medium. Each tape drive 18 is connected to the information processing apparatus 12. The tape drive 18 writes or reads data to or from the magnetic tape T under a control of the information processing apparatus 12. Examples of the magnetic tape T include a linear tape-open (LTO) tape.

In a case where the information processing apparatus 12 writes or reads data to or from the magnetic tape T, the magnetic tape T as a write target or a read target is loaded from the slot into a predetermined tape drive 18. In a case where data is written or read to and from the magnetic tape T loaded into the tape drive 18, the magnetic tape T is unloaded from the tape drive 18 into the slot in which the magnetic tape T is originally included.

Next, a hardware configuration of the information processing apparatus 12 according to the present embodiment will be described with reference to FIG. 2. As illustrated in FIG. 2, the information processing apparatus 12 includes a central processing unit (CPU) 20, a memory 21 as a temporary memory area, and a non-volatile storage unit 22. Further, the information processing apparatus 12 includes a display 23 such as a liquid crystal display, an input device 24 such as a keyboard and a mouse, a network interface (I/F) 25 connected to a network, and an external I/F 26 to which each tape drive 18 is connected. The CPU 20, the memory 21, the storage unit 22, the display 23, the input device 24, the network I/F 25, and the external I/F 26 are connected to a bus 27.

The storage unit 22 is realized by a hard disk drive (HDD), a solid state drive (SSD), a flash memory, or the like. An information processing program 30 is stored in the storage unit 22 as a storage medium. The CPU 20 reads the information processing program 30 from the storage unit 22, develops the read information processing program 30 in the memory 21, and executes the developed information processing program 30.

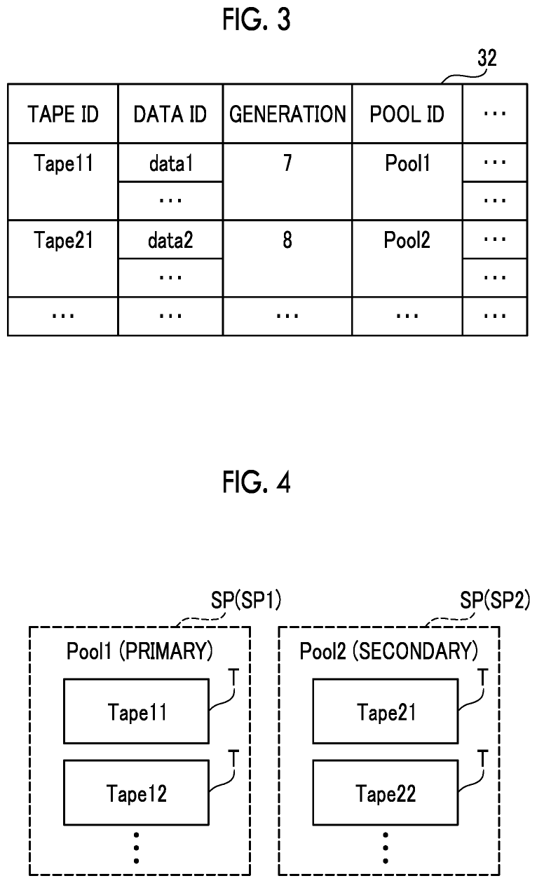

Further, the storage unit 22 stores a tape management table 32 for managing the magnetic tape T. FIG. 3 illustrates an example of the tape management table 32. As illustrated in FIG. 3, the tape management table 32 includes a tape identifier (ID) which is an example of identification information of the magnetic tape T and a data ID which is an example of identification information of the data recorded in the magnetic tape T.

Further, the tape management table 32 also includes information representing a generation of a standard of the magnetic tape T and a pool ID as an example of identification information of a storage pool to which the magnetic tape T belongs. The generation of the standard of the magnetic tape T is, for example, LTO7, LTO8, or the like. In the following, the generation of the standard of the magnetic tape T is simply referred to as a “generation”. In the tape library 14, a plurality of generations (two generations in the present embodiment) of magnetic tapes Ts are included. In the following, in the two generations, a relatively-old generation is referred to as an “old generation”, and a relatively-new generation is referred to as a “new generation”.

The tape library 14 according to the present embodiment includes a plurality of generations (two generations in the present embodiment) of the tape drives 18 in accordance with the generations of the magnetic tapes Ts. The old-generation tape drive 18 can read and write data only from and to the old-generation magnetic tape T among the two generations of magnetic tapes Ts. The new-generation tape drive 18 can read and write data from and to each of the two generations of magnetic tapes Ts.

Further, in the information processing system 10 according to the present embodiment, data is recorded with redundancy. Specifically, as an example, as illustrated in FIG. 4, a plurality of storage pool SPs, each including a plurality of magnetic tapes Ts, are prepared. A first storage pool SP is a storage pool SP for primary data, and a second storage pool SP is a storage pool SP for secondary data. In the following, in a case of distinguishing two storage pools SPs, a storage pool SP for primary data is referred to as a storage pool SP1, and a storage pool SP for secondary data is referred to as a storage pool SP2.

The same data is multiplexed and recorded in the two storage pools SPs. That is, a multiplicity is 2. The multiplicity is not limited to 2, and may be 3 or more. Further, each of the two storage pools SPs includes a plurality of generations of magnetic tapes Ts. In a case where data transmitted from a user terminal (not illustrated) is received, the information processing apparatus 12 performs control of recording the data in each of the two storage pools SPs. Normally, data is read from the magnetic tape T included in the storage pool SP1. In a case where data cannot be read from the storage pool SP1, data is read from the magnetic tape T included in the storage pool SP2.

In a case where the information processing apparatus 12 performs control of recording data in each of the two storage pools SPs, the information processing apparatus 12 may perform control of recording data in the storage pool SP without designating the magnetic tape T as a data recording destination. For example, in a case where the control is performed, the magnetic tapes Ts in each storage pool SP are used as a data recording destination in a predetermined order by a software program that manages the storage pools SPs. For example, the magnetic tapes Ts are used in order from the magnetic tape T having a smallest number at the end of the tape ID. Specifically, for example, in “Pool1”, first, a magnetic tape T having a tape ID of “Tape11” is used, and in a case where data cannot be added to the magnetic tape T having a tape ID of “Tape11”, then a magnetic tape T having a tape ID of “Tape12” is used. The order in which the magnetic tapes Ts in the storage pool SP are used is not limited to the above example. For example, the magnetic tapes Ts may be used in order from the magnetic tape T having a largest free capacity.

In a case where a free capacity of the storage pool SP becomes small, a new unused magnetic tape T is added to the storage pool SP, and thus the free capacity of the storage pool SP can be increased. The free capacity of the storage pool SP corresponds to a total value of free capacities of the magnetic tapes Ts included in the storage pool SP.

At this time, in consideration of an additional cost of the magnetic tape T and the like, not only a new-generation magnetic tape T but also an old-generation magnetic tape T which is cheaper than the new-generation magnetic tape T may be added. In this case, the information processing apparatus 12 updates the tape management table 32 such that a new-generation magnetic tape T is added to the storage pool SP1 and an old-generation magnetic tape T is added to the storage pool SP2.

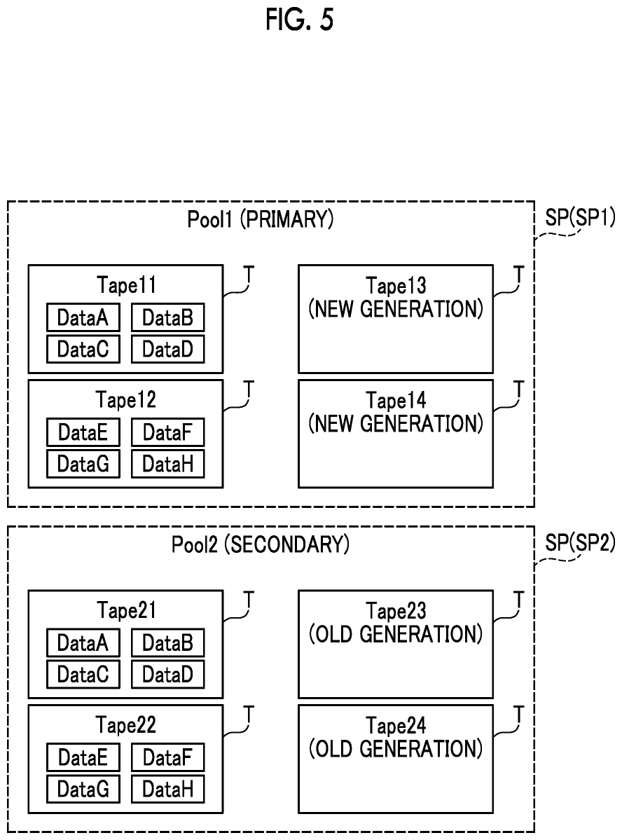

A specific example of the storage pool SP after a magnetic tape T is added will be described with reference to FIG. 5. FIG. 5 illustrates an example in which two old-generation magnetic tapes Ts in each of the two storage pool SPs are short of free capacity and two new magnetic tapes Ts are added to each of the two storage pool SPs. Here, it is assumed that, among four new magnetic tapes, two magnetic tapes are new-generation magnetic tapes Ts and two magnetic tapes are old-generation magnetic tapes Ts. As illustrated in FIG. 5, the information processing apparatus 12 adds two new-generation magnetic tapes Ts to the storage pool SP1, and adds two old-generation magnetic tapes Ts to the storage pool SP2. As a result, in the storage pool SP1, a data recordable area exists only in the new-generation magnetic tape T among the plurality of generations of magnetic tapes Ts.

As described above, in the present embodiment, the information processing apparatus 12 adds a new-generation magnetic tape T to the storage pool SP1 for primary data instead of the storage pool SP2 for secondary data. Thereby, access performance of the storage pool SP1 that is preferentially used can be improved as compared with a case where a new-generation magnetic tape T is added to the storage pool SP2.

The configuration of the storage pool SP illustrated in FIG. 5 is an example, and is not limited to the configuration example. At least one storage pool SP may be configured such that a data recordable area exists only in a new-generation magnetic tape T among the plurality of generations of magnetic tapes. For example, in the example of FIG. 5, at least one magnetic tape T of two magnetic tapes T added to the storage pool SP2 may be a new-generation magnetic tape T.

FIG. 5 illustrates an example in which a new magnetic tape T is added to the existing storage pool SP. On the other hand, in a case where a new storage pool SP is created, the storage pool SP may be similarly configured. In this case, for example, the storage pool SP1 is configured to include only a new-generation magnetic tape T among the two generations of magnetic tapes T.

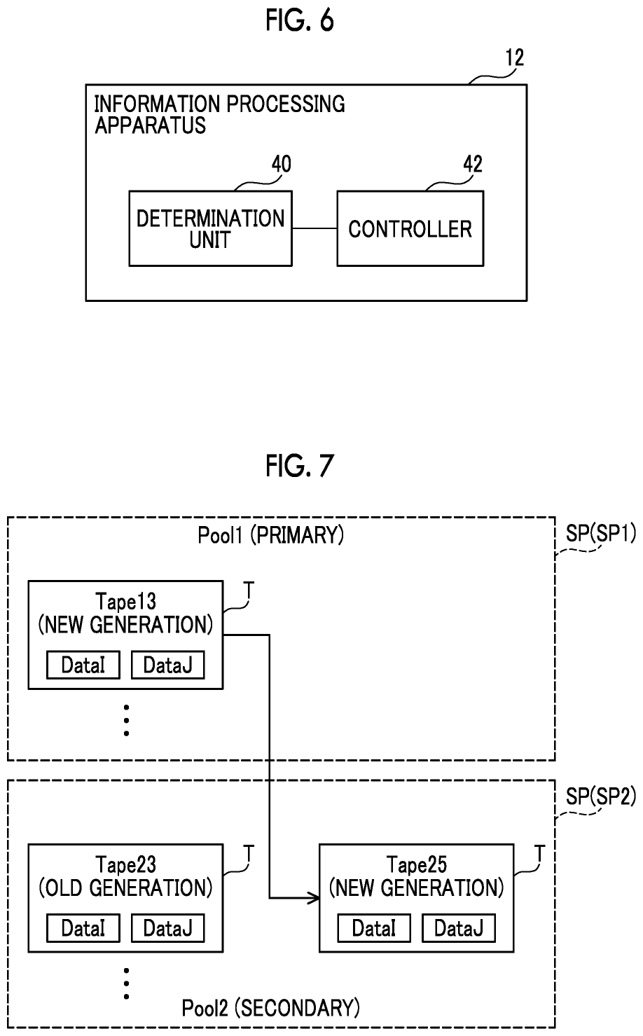

Next, a functional configuration of the information processing apparatus 12 in a case of recording data in the storage pool SP configured as described above and in a case of migrating data recorded in the storage pool SP will be described with reference to FIG. 6. As illustrated in FIG. 6, the information processing apparatus 12 includes a reception unit 40 and a controller 42. In a case where the CPU 20 executes the information processing program 30, the information processing apparatus 12 functions as the reception unit 40 and the controller 42.

The reception unit 40 receives data to be recorded, the data being transmitted from a user terminal (not illustrated). Further, the reception unit 40 receives a data migration instruction. The data migration instruction may be transmitted from the user terminal or may be input via the input device 24.

The controller 42 performs control of recording data to be recorded in each of the two storage pools SPs, the data being received by the reception unit 40. At this time, the controller 42 performs control of recording data with designating the storage pool SP as a recording destination and without designating the magnetic tape T as a data recording destination. As described above, in the storage pool SP1, a data recordable area exists only in a new-generation magnetic tape T among the plurality of generations of magnetic tapes Ts. Therefore, the controller 42 performs control of recording data in the new-generation magnetic tape T of the storage pool SP1.

Further, in a case where the reception unit 40 receives a data migration instruction, the controller 42 performs migration of data recorded in the magnetic tape T. For example, a magnetic tape T that is used for a certain period or longer, a magnetic tape T on which reading and writing are performed a certain number of times or more, a magnetic tape T of which an error rate in reading and writing is equal to or higher than a certain value, or the like is selected as a data-migration-source magnetic tape T. Further, for example, the magnetic tape T in which a ratio of pieces of data to be physically deleted (hereinafter, referred to as “data to be deleted”) is equal to or higher than a certain value or the magnetic tape T in which a total value of sizes of pieces of data to be deleted is equal to or larger than a certain value is selected as a data-migration-source magnetic tape T. Examples of data to be deleted include data of which a storage period is expired, data which is logically deleted, and the like.

In a case where data to be migrated that is recorded in the old-generation magnetic tape T of the storage pool SP2 is migrated to a new-generation magnetic tape T and in a case where the data to be migrated is recorded in the new-generation magnetic tape T of the storage pool SP1 other than the storage pool SP2, the controller 42 performs control of migrating data as described below. In this case, the controller 42 performs control of migrating data to be migrated from the new-generation magnetic tape T of the storage pool SP1 to the new-generation magnetic tape T of the storage pool SP2. In data migration, in a case where data to be deleted is included in the data-migration-source magnetic tape T, the controller 42 may not migrate the data to be deleted.

A specific example of data migration will be described with reference to FIG. 7. Here, as illustrated in FIG. 7, a case where one old-generation magnetic tape T of the storage pool SP2 is used as a data-migration-source magnetic tape T will be described as an example. Further, it is assumed that a new-generation magnetic tape T is added to the storage pool SP2 as a migration destination of the data from the data-migration-source magnetic tape T.

At this time, it is considered that the controller 42 performs control of reading data from the data-migration-source magnetic tape T of the storage pool SP2 and performs control of recording the data obtained by the control in the new-generation magnetic tape T as a migration destination. On the other hand, as described above, in the storage pool SP1, a data recordable area exists only in the new-generation magnetic tape T. Thus, the same data as the data recorded in the data-migration-source magnetic tape T of the storage pool SP2 is recorded in the new-generation magnetic tape T.

Therefore, in the present embodiment, as illustrated in FIG. 7, the controller 42 performs control of reading data to be migrated from the new-generation magnetic tape T of the storage pool SP1 in which the same data as the data recorded in the data-migration-source magnetic tape T of the storage pool SP2 is recorded. Then, the controller 42 performs control of recording the data to be migrated that is obtained by the control in the new-generation magnetic tape T as a data migration destination of the storage pool SP2. Thereby, the controller 42 can read the data to be migrated from the new-generation magnetic tape T by using a new-generation tape drive 18. Therefore, it is possible to shorten a time required for data migration as compared with a case where the data to be migrated is read from the old-generation magnetic tape T by using an old-generation tape drive 18.

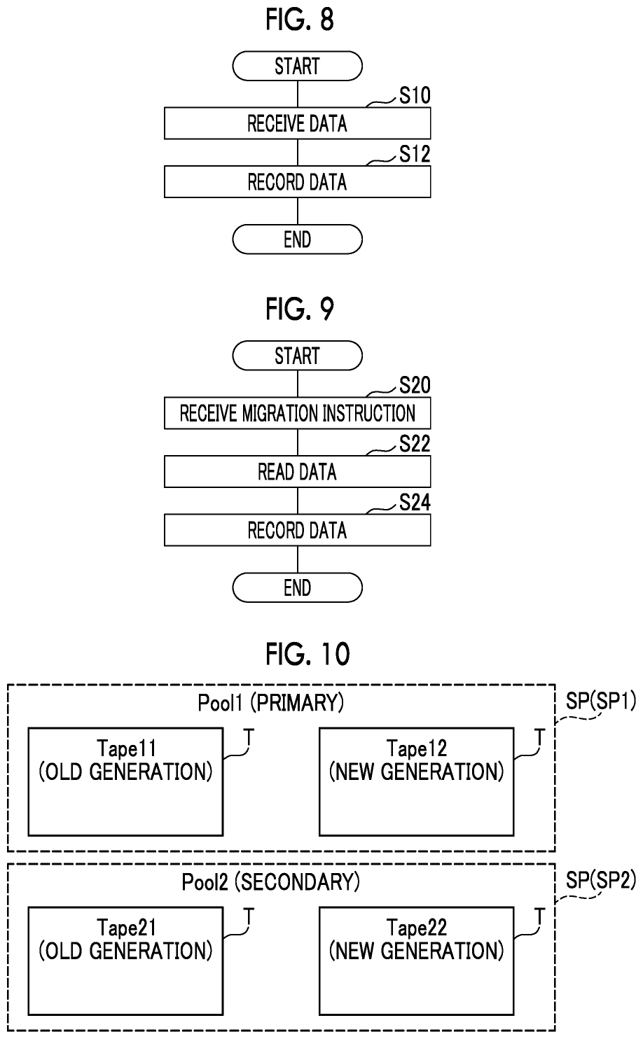

Next, an operation of the information processing apparatus 12 according to the present embodiment will be described with reference to FIG. 8 and FIG. 9. In a case where the CPU 20 executes the information processing program 30, data recording processing illustrated in FIG. 8 and data migration processing illustrated in FIG. 9 are executed. The data recording processing illustrated in FIG. 8 is executed, for example, in a case where the information processing apparatus 12 receives data to be recorded that is transmitted from the user terminal. Further, the data migration processing illustrated in FIG. 9 is executed, for example, in a case where the information processing apparatus 12 receives a data migration instruction. Here, it is assumed that the data-migration-source magnetic tape T is an old-generation magnetic tape T of the storage pool SP2 and the same data as the data recorded in the magnetic tape T is recorded in the new-generation magnetic tape T of the storage pool SP1.

In step S10 of FIG. 8, the reception unit 40 receives data to be recorded that is transmitted from the user terminal. In step S12, as described above, the controller 42 performs control of recording the data to be recorded that is received in step S10 in each of the two storage pools SPs. In a case where the processing of step S12 is completed, data recording processing is completed.

In step S20 of FIG. 9, the reception unit 40 receives a data migration instruction. In step S22, the controller 42 performs control of reading data to be migrated from the new-generation magnetic tape T of the storage pool SP1 in which the same data as the data recorded in the data-migration-source magnetic tape T of the storage pool SP2 is recorded. In step S24, the controller 42 performs control of recording the data to be migrated that is read in step S22 in the new-generation magnetic tape T as a data migration destination of the storage pool SP2. In a case where the processing of step S24 is completed, data migration processing is completed.

The controller 42 may perform control of initializing the data-migration-source magnetic tape T of the storage pool SP2 after the data migration processing is completed. In this case, the initialized magnetic tape T can be reused. Further, the controller 42 may perform control of unloading the data-migration-source magnetic tape T of the storage pool SP2 from the tape library 14 after the data migration processing is completed. In this case, a new magnetic tape T can be included in the tape library 14 instead of the unloaded magnetic tape T.

As described above, according to the present embodiment, it is possible to shorten a time required for data migration.

In the above embodiment, a case where a data recordable area exists only in a new-generation magnetic tape T among the plurality of generations of magnetic tapes Ts in at least one storage pool SP and thus data is recorded in the new-generation magnetic tape T of at least one storage pool SP among the plurality of storage pools SPs has been described. On the other hand, the present disclosure is not limited thereto.

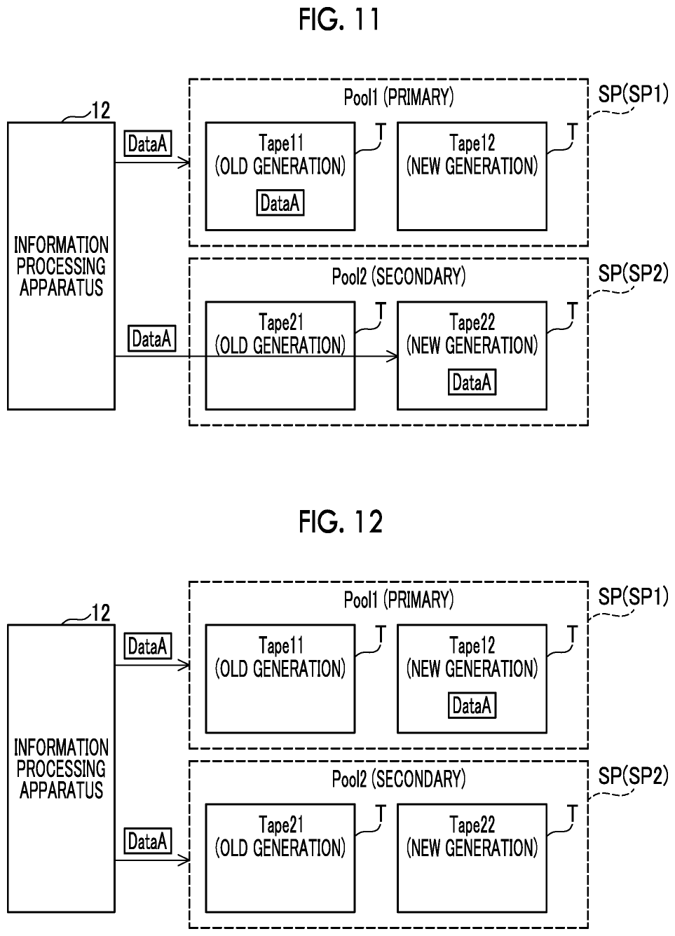

As illustrated in FIG. 10, a case where a data recordable area exists in both the old-generation magnetic tape T and the new-generation magnetic tape T in each of the two storage pools SPs will be described as an example. In this case, as illustrated in FIG. 11, the controller 42 performs control of recording data in one storage pool SP (storage pool SP1 in the example of FIG. 11) without designating the magnetic tape T as a data recording destination. As illustrated in FIG. 11, in a case where the control is performed and thus data is recorded in the old-generation magnetic tape T of one storage pool SP, the controller 42 performs control of designating, as a magnetic tape T as a data recording destination, a new-generation magnetic tape T of the storage pool SP (storage pool SP2 in the example of FIG. 11) other than the one storage pool SP and then recording data in the new-generation magnetic tape T. FIG. 11 illustrates an example in which “Tape22” is designated as the magnetic tape T as a data recording destination in the storage pool SP2.

On the other hand, as illustrated in FIG. 12, the controller 42 performs control of recording data in one storage pool SP (storage pool SP1 in the example of FIG. 12) without designating the magnetic tape T as a data recording destination. As illustrated in FIG. 12, in a case where the control is performed and thus data is recorded in the new-generation magnetic tape T of one storage pool SP, the controller 42 performs control of recording data without designating a magnetic tape T as a data recording destination in the storage pool SP (storage pool SP2 in the example of FIG. 12) other than the one storage pool SP. In this case, data is recorded in any one of a new-generation magnetic tape T and an old-generation magnetic tape T by the software program that manages the storage pool SP.

Therefore, even in the embodiment, data is recorded in the new-generation magnetic tape T of at least one storage pool SP among the plurality of storage pools SPs.

Further, in the above embodiment, the storage pool SP may include magnetic tapes Ts of three or more generations.

Further, in the embodiment, for example, as a hardware structure of a processing unit that executes various processing such as the reception unit 40 and the controller 42, the following various processors may be used. The various processors include, as described above, a CPU, which is a general-purpose processor that functions as various processing units by executing software (program), and a dedicated electric circuit, which is a processor having a circuit configuration specifically designed to execute a specific processing, such as a programmable logic device (PLD) or an application specific integrated circuit (ASIC) that is a processor of which the circuit configuration may be changed after manufacturing such as a field programmable gate array (FPGA).

One processing unit may be configured by one of these various processors, or may be configured by a combination of two or more processors of the same type or different types (for example, a combination of a plurality of FPGAs or a combination of a CPU and an FPGA). Further, the plurality of processing units may be configured by one processor.

As an example in which the plurality of processing units are configured by one processor, firstly, as represented by a computer such as a client and a server, a form in which one processor is configured by a combination of one or more CPUs and software and the processor functions as the plurality of processing units may be adopted. Secondly, as represented by a system on chip (SoC) or the like, a form in which a processor that realizes the function of the entire system including the plurality of processing units by one integrated circuit (IC) chip is used may be adopted. As described above, the various processing units are configured by using one or more various processors as a hardware structure.

Further, as the hardware structure of the various processors, more specifically, an electric circuit (circuitry) in which circuit elements such as semiconductor elements are combined may be used.

Further, in the embodiment, an example in which the information processing program 30 is stored (installed) in the storage unit 22 in advance has been described. On the other hand, the present disclosure is not limited thereto. The information processing program 30 may be provided by being recorded in a recording medium such as a compact disc read only memory (CD-ROM), a digital versatile disc read only memory (DVD-ROM), or a Universal Serial Bus (USB) memory. Further, the information processing program 30 may be downloaded from an external device via a network.

What is claimed is:

1. An information processing apparatus comprising:
at least one processor,
wherein the processor is configured to perform control of recording data in a relatively-new-generation magnetic tape of at least one storage pool among a plurality of storage pools in a case where the same data is recorded in each of the plurality of storage pools each of which includes a plurality of generations of magnetic tapes.

2. The information processing apparatus according to claim 1,
wherein a data recordable area exists only in the relatively-new-generation magnetic tape among the plurality of generations of magnetic tapes in the at least one storage pool.

3. The information processing apparatus according to claim 1,
wherein the processor is configured to
perform control of recording data in the one storage pool without designating a magnetic tape as a data recording destination, and
perform control of recording data without designating a magnetic tape as a data recording destination in a storage pool other than the one storage pool in a case where the control is performed and data is recorded in the relatively-new-generation magnetic tape of the one storage pool, and perform control of designating a relatively-new-generation magnetic tape as a data recording destination in at least one storage pool other than the one storage pool and recording data in the designated magnetic tape in a case where data is recorded in a relatively-old-generation magnetic tape in the one storage pool.

4. The information processing apparatus according to claim 1,
wherein the processor is configured to perform control of migrating data to be migrated from a relatively-new-generation magnetic tape of a second storage pool to a relatively-new-generation magnetic tape of a first storage pool in a case where the data to be migrated that is recorded in a relatively-old-generation magnetic tape of the first storage pool is migrated to a relatively-new-generation magnetic tape and in a case where the data to be migrated is recorded in the relatively-new-generation magnetic tape of the second storage pool other than the first storage pool.

5. The information processing apparatus according to claim 2,
wherein the processor is configured to perform control of migrating data to be migrated from a relatively-new-generation magnetic tape of a second storage pool to a relatively-new-generation magnetic tape of a first storage pool in a case where the data to be migrated that is recorded in a relatively-old-generation magnetic tape of the first storage pool is migrated to a relatively-new-generation magnetic tape and in a case where the data to be migrated is recorded in the relatively-new-generation magnetic tape of the second storage pool other than the first storage pool.

6. The information processing apparatus according to claim 3,
wherein the processor is configured to perform control of migrating data to be migrated from a relatively-new-generation magnetic tape of a second storage pool to a relatively-new-generation magnetic tape of a first storage pool in a case where the data to be migrated that is recorded in a relatively-old-generation magnetic tape of the first storage pool is migrated to a relatively-new-generation magnetic tape and in a case where the data to be migrated is recorded in the relatively-new-generation magnetic tape of the second storage pool other than the first storage pool.

7. An information processing method executed by a processor of an information processing apparatus, the method comprising:
performing control of recording data in a relatively-new-generation magnetic tape of at least one storage pool among a plurality of storage pools in a case where the same data is recorded in each of the plurality of storage pools each of which includes a plurality of generations of magnetic tapes.

8. The information processing method according to claim 7,
wherein a data recordable area exists only in the relatively-new-generation magnetic tape among the plurality of generations of magnetic tapes in the at least one storage pool.

9. The information processing method according to claim 7, the method further comprising:
performing control of recording data in the one storage pool without designating a magnetic tape as a data recording destination, and
performing control of recording data without designating a magnetic tape as a data recording destination in a storage pool other than the one storage pool in a case where the control is performed and data is recorded in the relatively-new-generation magnetic tape of the one storage pool, and performing control of designating a relatively-new-generation magnetic tape as a data recording destination in at least one storage pool other than the one storage pool and recording data in the designated magnetic tape in a case where data is recorded in a relatively-old-generation magnetic tape in the one storage pool.

10. The information processing method according to claim 7, the method further comprising:
performing control of migrating data to be migrated from a relatively-new-generation magnetic tape of a second storage pool to a relatively-new-generation magnetic tape of a first storage pool in a case where the data to be migrated that is recorded in a relatively-old-generation magnetic tape of the first storage pool is migrated to a relatively-new-generation magnetic tape and in a case where the data to be migrated is recorded in the relatively-new-generation magnetic tape of the second storage pool other than the first storage pool.

11. The information processing method according to claim 8, the method further comprising:
performing control of migrating data to be migrated from a relatively-new-generation magnetic tape of a second storage pool to a relatively-new-generation magnetic tape of a first storage pool in a case where the data to be migrated that is recorded in a relatively-old-generation magnetic tape of the first storage pool is migrated to a relatively-new-generation magnetic tape and in a case where the data to be migrated is recorded in the relatively-new-generation magnetic tape of the second storage pool other than the first storage pool.

12. The information processing method according to claim 9, the method further comprising:
performing control of migrating data to be migrated from a relatively-new-generation magnetic tape of a second storage pool to a relatively-new-generation magnetic tape of a first storage pool in a case where the data to be migrated that is recorded in a relatively-old-generation magnetic tape of the first storage pool is migrated to a relatively-new-generation magnetic tape and in a case where the data to be migrated is recorded in the relatively-new-generation magnetic tape of the second storage pool other than the first storage pool.

13. A non-transitory computer-readable storage medium storing an information processing program for causing a processor of an information processing apparatus to execute a process comprising:
performing control of recording data in a relatively-new-generation magnetic tape of at least one storage pool among a plurality of storage pools in a case where the same data is recorded in each of the plurality of storage pools each of which includes a plurality of generations of magnetic tapes.

14. The non-transitory computer-readable storage medium storing the information processing program according to claim 13,
wherein a data recordable area exists only in the relatively-new-generation magnetic tape among the plurality of generations of magnetic tapes in the at least one storage pool.

15. The non-transitory computer-readable storage medium storing the information processing program according to claim 13, the process further comprising:
performing control of recording data in the one storage pool without designating a magnetic tape as a data recording destination, and
performing control of recording data without designating a magnetic tape as a data recording destination in a storage pool other than the one storage pool in a case where the control is performed and data is recorded in the relatively-new-generation magnetic tape of the one storage pool, and performing control of designating a relatively-new-generation magnetic tape as a data recording destination in at least one storage pool other than the one storage pool and recording data in the designated magnetic tape in a case where data is recorded in a relatively-old-generation magnetic tape in the one storage pool.

16. The non-transitory computer-readable storage medium storing the information processing program according to claim 13, the process further comprising:
performing control of migrating data to be migrated from a relatively-new-generation magnetic tape of a second storage pool to a relatively-new-generation magnetic tape of a first storage pool in a case where the data to be migrated that is recorded in a relatively-old-generation magnetic tape of the first storage pool is migrated to a relatively-new-generation magnetic tape and in a case where the data to be migrated is recorded in the relatively-new-generation magnetic tape of the second storage pool other than the first storage pool.

17. The non-transitory computer-readable storage medium storing the information processing program according to claim 14, the process further comprising:
performing control of migrating data to be migrated from a relatively-new-generation magnetic tape of a second storage pool to a relatively-new-generation magnetic tape of a first storage pool in a case where the data to be migrated that is recorded in a relatively-old-generation magnetic tape of the first storage pool is migrated to a relatively-new-generation magnetic tape and in a case where the data to be migrated is recorded in the relatively-new-generation magnetic tape of the second storage pool other than the first storage pool.

18. The non-transitory computer-readable storage medium storing the information processing program according to claim 15, the process further comprising:
performing control of migrating data to be migrated from a relatively-new-generation magnetic tape of a second storage pool to a relatively-new-generation magnetic tape of a first storage pool in a case where the data to be migrated that is recorded in a relatively-old-generation magnetic tape of the first storage pool is migrated to a relatively-new-generation magnetic tape and in a case where the data to be migrated is recorded in the relatively-new-generation magnetic tape of the second storage pool other than the first storage pool.
